(19) United States
(12) Patent Application Publication
(10) Pub. No.: US 2026/0151709 A1
(43) Pub. Date: Jun. 4, 2026

(54) COLLAPSED GAME PLAY SESSION OF A VIDEO GAME

(71) Applicant: SONY INTERACTIVE ENTERTAINMENT LLC, San Mateo, CA (US)

(72) Inventor: Bethany TINKLENBERG, San Mateo, CA (US)

(21) Appl. No.: 19/368,513

(22) Filed: Oct. 24, 2025

Related U.S. Application Data
(60) Provisional application No. 63/727,641, filed on Dec. 3, 2024.

(51) Int. Cl. A63F 13/67

(52) U.S. Cl. CPC A63F 13/67

(57) ABSTRACT

A method including receiving a request originating from a player to continue playing a video game, wherein the request includes a user defined period of time for playing the video game. A current context is determined in a previous game play for the player. A first AI model is executed to identify a storyline segment in the video game based on the current context, wherein the storyline segment includes a predefined goal. The first AI model is configured to determine one or more primary moments in the storyline segment that are required for achieving the predefined goal, and to determine a secondary moment that is unnecessary to achieve the predefined goal. A second AI model is executed to provide a collapsed game play session, wherein play is allowed through the one or more primary moments and play is restricted for the secondary moment.

### CROSS-REFERENCE TO RELATED APPLICATION

This application claims the priority benefit of U.S. Provisional Patent Application No. 63/727,641 filed December 3, 2024, which is incorporated by reference herein in its entirety for all purposes.

### TECHNICAL FIELD

The present disclosure is related to providing a collapsed gaming experience for a video game over a defined period of time that is customized to include essential moments with consideration of a universal gaming style of the player and historical game play of the video game by the player.

### BACKGROUND OF THE DISCLOSURE

Video games and/or gaming applications and their related industries (e.g., video gaming) are extremely popular and represent a large percentage of the worldwide entertainment market. Video games are played anywhere and at any time using various types of platforms, including gaming consoles, desktop computers, laptop computers, mobile phones, tablet computers, etc.

When playing a video game, sometimes a player is unable to devote an extended period of time for playing a session. For example, the user may be busy with work, or household tasks, or family matters, and cannot devote much time to gaming over the short or long term. However, the user still wants to play the video game, and furthermore continue advancing through the video game. Though pressed for time, the user may start a gaming session and play for a short period of time. The game is presented to the user normally. That is, the game is making available all the options to the user for playing the video game. Further, the user may not understand what is required to complete the next portion of the game, and in fact may be playing in a manner that does not actually advance the user through the video game.

It is in this context that embodiments of the disclosure arise.

### SUMMARY

Embodiments of the present disclosure relate to providing a collapsed gaming experience for a video game that includes essential moments. In particular, artificial intelligence is used to identify a storyline segment for a corresponding point in the game, and identify one or moments associated with that segment that are necessary for completing that storyline segment. Further, artificial intelligence is used to control a collapsed game play session for a user defined period of time that guides the user through those essential moments and restricts play of moments that are not necessary for completing the storyline segment. In that manner, the corresponding player is able to efficiently play the video game in a shortened amount of time by still advancing through the video game.

In one embodiment, a method is disclosed. The method including receiving a request originating from a player to continue playing a video game, wherein the request includes a user defined period of time for playing the video game. The method including determining a current context in a previous game play of the video game for the player. The method including executing a first AI model to identify a storyline segment in the video game based on the current context, wherein the video game includes a storyline including a plurality of storyline segments, wherein the storyline segment includes a predefined goal. The method including determining using the first AI model one or more primary moments in the storyline segment that are required for achieving the predefined goal, wherein the first AI model determines a secondary moment in the storyline segment that is unnecessary to achieve the predefined goal. The method including executing a second AI model to provide a collapsed game play session for the player, wherein the second AI model is configured to allow play through the one or more primary moments and to restrict play of the secondary moment in the storyline segment.

In another embodiment, a non-transitory computer-readable medium storing a computer program for performing a method is disclosed. The non-transitory computer-readable medium including program instructions for receiving a request originating from a player to continue playing a video game, wherein the request includes a user defined period of time for playing the video game. The non-transitory computer-readable medium including program instructions for determining a current context in a previous game play of the video game for the player. The non-transitory computer-readable medium including program instructions for executing a first AI model to identify a storyline segment in the video game based on the current context, wherein the video game includes a storyline including a plurality of storyline segments, wherein the storyline segment includes a predefined goal. The non-transitory computer-readable medium including program instructions for determining using the first AI model one or more primary moments in the storyline segment that are required for achieving the predefined goal, wherein the first AI model determines a secondary moment in the storyline segment that is unnecessary to achieve the predefined goal. The non-transitory computer-readable medium including program instructions for executing a second AI model to provide a collapsed game play session for the player, wherein the second AI model is configured to allow play through the one or more primary moments and to restrict play of the secondary moment in the storyline segment.

In still another embodiment, a computer system is disclosed, wherein the computer system includes a processor and memory coupled to the processor and having stored therein instructions that, if executed by the computer system, cause the computer system to execute a method. The method including receiving a request originating from a player to continue playing a video game, wherein the request includes a user defined period of time for playing the video game. The method including determining a current context in a previous game play of the video game for the player. The method including executing a first AI model to identify a storyline segment in the video game based on the current context, wherein the video game includes a storyline including a plurality of storyline segments, wherein the storyline segment includes a predefined goal. The method including determining using the first AI model one or more primary moments in the storyline segment that are required for achieving the predefined goal, wherein the first AI model determines a secondary moment in the storyline segment that is unnecessary to achieve the predefined goal. The method including executing a second AI model to provide a collapsed game play session for the player, wherein the second AI model is configured to allow play through the one or more primary moments and to restrict play of the secondary moment in the storyline segment.

Other aspects of the disclosure will become apparent from the following detailed description, taken in conjunction with the accompanying drawings, illustrating by way of example the principles of the disclosure.

### BRIEF DESCRIPTION OF THE DRAWINGS

The disclosure may best be understood by reference to the following description taken in conjunction with the accompanying drawings in which:

FIG. 1 illustrates a system configured for a collapsed game play session of a video game, in accordance with one embodiment of the present disclosure.

FIGS. 2A-2B are flow diagrams illustrating methods for providing a collapsed game play session for a video game over a user defined period of time, in accordance with one embodiment of the present disclosure.

FIG. 3 is an illustration of a system configured to implement an AI model configured for implementing a collapsed game play session of a video game, in accordance with one embodiment of the present disclosure.

FIG. 4A is a diagram illustrating one or more paths capable of being played for a storyline segment of a video game, in accordance with one embodiment of the present disclosure.

FIG. 4B is a diagram illustrating moments identified using artificial intelligence for a predicted path taken by a player playing a storyline segment in a collapsed game play session of a video game, in accordance with one embodiment of the present disclosure.

FIG. 5 illustrates a user interface configured for enabling user modification of player characteristics corresponding to a game play style when implementing a collapsed game play session of a video game, in accordance with one embodiment of the present disclosure.

FIG. 6 illustrates components of an example device that can be used to perform aspects of the various embodiments of the present disclosure.

### DETAILED DESCRIPTION

Although the following detailed description contains many specific details for the purposes of illustration, anyone of ordinary skill in the art will appreciate that many variations and alterations to the following details are within the scope of the present disclosure. Accordingly, the aspects of the present disclosure are set forth without any loss of generality to, and without imposing limitations upon, the claims that follow this description.

Generally speaking, the various embodiments of the present disclosure describe systems and methods for providing a collapsed gaming experience for a video game over a defined period of time, that is customized to include essential moments with consideration of a universal gaming style of the player and historical game play of the video game by the player. In particular, artificial intelligence can be used to identify a storyline segment for a corresponding point in the video game, and identify one or moments associated with that segment that are necessary for completing that storyline segment. Also, artificial intelligence is used to control a collapsed game play session for a user defined period of time that guides the player through those essential moments and restricts play of moments that are not necessary for completing the storyline segment. The collapsed game play may continue a gaming experience of a player that has been continuously playing the video game, or may be based off a recorded game play of another player playing the video game. That is, the collapsed game play session is implemented by taking key or essential moments from gameplay of the video game by a player, or from recorded highlight reels generated from gameplay by other players. In that manner, the player is able to advance through the video game during the collapsed game play session, and also play moments of the game that are enjoyable to the player, even though those moments may not necessarily advance the player through the video game, and also simulate an experience of playing a video game that is shown in the recorded game play.

Advantages of the methods and systems, configured to provide a collapsed gaming experience for a video game over a defined period of time, include providing for a full gaming experience for players with limited time to play. The collapsed gaming experience can be played based on time segments, sizzle reel entry points, and queued to console for later gameplay. That is, the collapsed gaming experience can have various entries into the game play, such as one based on the previous and continuing game play of the player, and one based on inciting interest through a generated (playable) sizzle reel. In both cases, a collapsed game play session of the video game allows the player to jump into and play key moments of the video game. The player is still able to advance through a video game in the shortened period of time because the collapsed game play session guides the player through essential moments of the corresponding storyline segment. The player is also able to play moments of the game that are enjoyable to the player, even though those moments may not necessarily advance the player through the video game, based on user preferences. Also, a player is able to enjoy and experience playing a segment of a video game that is shown in a recorded game play by another player. As such, in the shortened period of time, the player is able to jump into playing that moment or those collections of moments, without needing to play the entire storyline available to the player.

Throughout the specification, the reference to “game” or “video game” or “gaming application” is meant to represent any type of interactive application that is directed through execution of input commands. For illustration purposes only, an interactive application includes applications for gaming, word processing, video processing, video game processing, etc. Also, the terms “virtual world” or “virtual environment” or “metaverse” is meant to represent any type of environment generated by a corresponding application or applications for interaction between a plurality of users in a multi-player session or multi-player gaming session. Furthermore, the term “platform” refers to a combination of hardware and software components providing a set of capabilities in order to execute one or more software applications (e.g., video games). For example, the term “platform” may be used with reference to “devices of a particular platform” or “cross-platform devices.” Moreover, suitable terms introduced above are interchangeable.

With the above general understanding of the various embodiments, example details of the embodiments will now be described with reference to the various drawings.

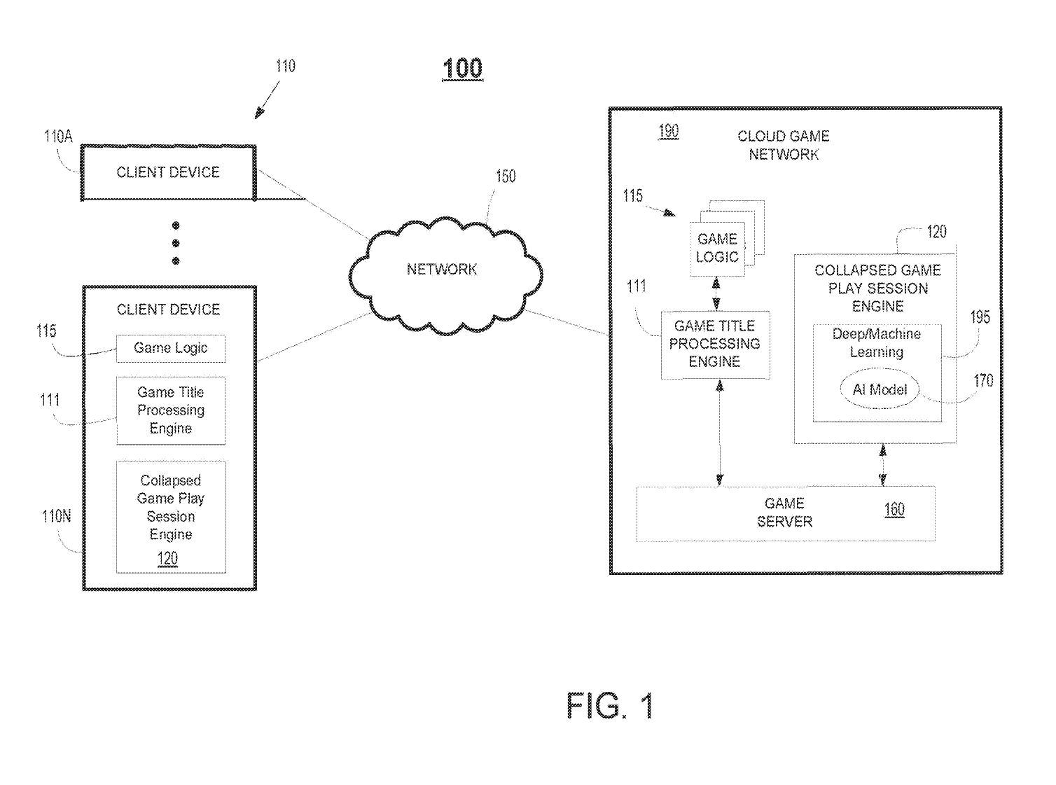

FIG. 1 illustrates a system 100 configured for providing a collapsed game play session of a video game, using artificial intelligence, in accordance with one embodiment of the present disclosure. In that manner, artificial intelligence is used to control a collapsed gaming experience over a period of time that is customized to include essential moments with consideration of a universal gaming style of the player and historical game play of the video game by the player.

As shown, system 100 may provide gaming over a network 150 for one or more client devices 110 (e.g., 110A through 110N) of one or more users. In particular, system 100 may be configured to enable users to interact with interaction applications, including providing gaming to users participating in a single-player or multi-player gaming sessions (e.g., participating in a video game in single-player or multi-player mode, or participating in a metaverse generated by an application with other users, etc.) via a cloud game network 190, wherein the game can be executed locally (e.g., on a local client device 110 of a corresponding user) or can be executed remotely from a corresponding client device 110 (e.g., acting as a thin client) of the corresponding user that is playing the video game, in accordance with one embodiment of the present disclosure. In at least one capacity, the cloud game network 190 supports a multi-player gaming session for a group of users, to include delivering and receiving game data of players for purposes of coordinating and/or aligning objects and actions of players within a scene of a gaming world or metaverse, managing communications between user, etc., so that the users in distributed locations participating in a multi-player gaming session can interact with each other in the gaming world or metaverse in real-time. In another capacity, the cloud game network 190 supports multiple users participating in a metaverse.

In some embodiments, the cloud game network 190 may include a plurality of virtual machines (VMs) running on a hypervisor of a host machine, with one or more virtual machines configured to execute a game processor module utilizing the hardware resources available to the hypervisor of the host. It should be noted, that access services, such as providing access to games of the current embodiments, delivered over a wide geographical area often use cloud computing. Cloud computing is a style of computing in which dynamically scalable and often virtualized resources are provided as a service over the internet.

In a multi-player session allowing participation for a group of users to interact within a gaming world or metaverse generated by an application (which may be a video game), some users may be executing an instance of the application locally on a client device (e.g., gaming console, tablet, mobile phone, etc.) to participate in the multi-player session. Other users who do not have the application installed on a selected device or when the selected device is not computationally powerful enough to executing the application may be participating in the multi-player session via a cloud based instance of the application executing at the cloud game network 190.

As shown, the cloud game network 190 includes a game server 160 that provides access to a plurality of video games. Applications played in a corresponding single player and/or multi-player session may be played over the network 150 with connection to the game server 160. For example, in a multi-player session involving multiple instances of an application (e.g., generating virtual environment, gaming world, metaverse, etc.), a dedicated server application (session manager) collects data from users and distributes it to other users so that all instances are updated as to objects, characters, etc. to allow for real-time interaction within the virtual environment of the multi-player session, wherein the users may be executing local instances or cloud based instances of the corresponding application. In particular, game server 160 may manage a virtual machine supporting a game processor that instantiates a cloud based instance of an application for a user. As such, a plurality of game processors of game server 160 associated with a plurality of virtual machines is configured to execute multiple instances of one or more applications associated with gameplays of a plurality of users. In that manner, back-end server support provides streaming of media (e.g., video, audio, etc.) of gameplays of a plurality of applications (e.g., video games, gaming applications, etc.) to a plurality of corresponding users. That is, game server 160 is configured to stream data (e.g., rendered images and/or frames of a corresponding gameplay) back to a corresponding client device 110 through network 150. As such, a computationally complex gaming application may be executing at the back-end server in response to controller inputs received and forwarded by client device 110. Each server is able to render images and/or frames that are then encoded (e.g., compressed) and streamed to the corresponding client device for display.

In single-player or multi-player sessions, instances of an application may be executing locally on a client device 110 or at the cloud game network 190. In either case, the application as game logic 115 is executed by a game engine 111 (e.g., game title processing engine). For purposes of clarity and brevity, the implementation of game logic 115 and game engine 111 is described within the context of the cloud game network 190. In particular, the application may be executed by a distributed game title processing engine (referenced herein as “game engine”). In particular, game server 160 and/or the game title processing engine 111 includes basic processor based functions for executing the application and services associated with the application. For example, processor based functions include 2D or 3D rendering, physics, physics simulation, scripting, audio, animation, graphics processing, lighting, shading, rasterization, ray tracing, shadowing, culling, transformation, artificial intelligence, etc. In that manner, the game engines implement game logic, perform game calculations, physics, geometry transformations, rendering, lighting, shading, audio, as well as additional in-game or game-related services. In addition, services for the application include memory management, multi-thread management, quality of service (QoS), bandwidth testing, social networking, management of social friends, communication with social networks of friends, social utilities, communication channels, audio communication, texting, messaging, instant messaging, chat support, game play replay functions, help functions, etc.

In one embodiment, the cloud game network 190 may support artificial intelligence (AI) based services including chatbot services (e.g., ChatGPT, etc.) that provide for one or more features, such as conversational communications, composition of written materiel, composition of music, answering questions, simulating a chat room, playing games, and others.

Users access the remote services with client devices 110, which include at least a CPU, a display and input/output (I/O). For example, users may access cloud game network 190 via communications network 150 using corresponding client devices 110 configured for providing input control, updating a session controller (e.g., delivering and/or receiving user game state data), receiving streaming media, etc. The client device 110 can be a personal computer (PC), a mobile phone, a personal digital assistant (PAD), handheld device, etc.

The client devices 110 may be operating using different platforms. For example, one or more client devices may be operating on a first platform (e.g., gaming consoles), and other client devices may be operating a different platform (mobile phones). In still another platform, a platform includes both a client device and game server 160 located at the cloud game network 190 in support of a cloud based instance of an application. As previously described, each platform may include a combination of hardware and software components providing a set of capabilities in order to execute one or more software applications (e.g., video games).

In particular, client device 110 of a corresponding user is configured for requesting access to applications over a communications network 150, such as the internet, and for rendering for display images generated by a video game executed by the game server 160, wherein encoded images are delivered (i.e., streamed) to the client device 110 for display. For example, the user may be interacting through client device 110 with an instance of an application executing on a game processor of game server 160 using input commands to drive a gameplay. Client device 110 may receive input from various types of input devices, such as game controllers, tablet computers, keyboards, touch screens, gestures captured by video cameras, mice, touch pads, audio input, etc.

As previously introduced, client device 110 may be configured with a game title processing engine 111 and game logic 115 (e.g., executable code) that is locally stored for at least some local processing of an application, and may be further utilized for receiving streaming content as generated by the application executing at a server, or for other content provided by back-end server support. In another implementation, client decide 110 acts as a stand-alone system for purposes of executing the application, such as when supporting a game play of a video game.

In another embodiment, client device 110 may be configured as a thin client providing interfacing with a back end server (e.g., game server 160 of cloud game network 190) configured for providing computational functionality (e.g., including game title processing engine 111 executing game logic 115 – i.e., executable code – implementing a corresponding application).

In addition, system 100 includes a collapsed game play engine 120 configured to provide a collapsed gaming experience for a video game over a defined period of timeusing artificial intelligence. In particular, artificial intelligence can be used to implement a collapsed game play session of a video game that is customized to include essential moments with consideration of a universal gaming style of the player and historical game play of the video game by the player. For example, artificial intelligence is used to identify a storyline segment for a corresponding point in the game, and identify one or moments associated with that segment that are necessary for completing that storyline segment. Also, artificial intelligence is used to control a collapsed game play session for a user defined period of time that guides the player through those essential moments and restricts play of moments that are not necessary for completing the storyline segment. In that manner, the corresponding player is able to efficiently play the video game in a shortened amount of time that allows for advancement through the video game, and also provides for playing moments of the game that are enjoyable to the player even though those moments may not necessarily advance the player through the video game.

The collapsed game play engine 120 may be implemented at the back-end cloud game network, or as a middle layer third party service that is remote from the client device. In some implementations, the collapsed game play engine 120 may be located at a client device 110. That is, the collapsed game play engine 120 may be local to a user, such as operating within a client device 110 of the user, or may be remote from the user and operate at a back-end server.

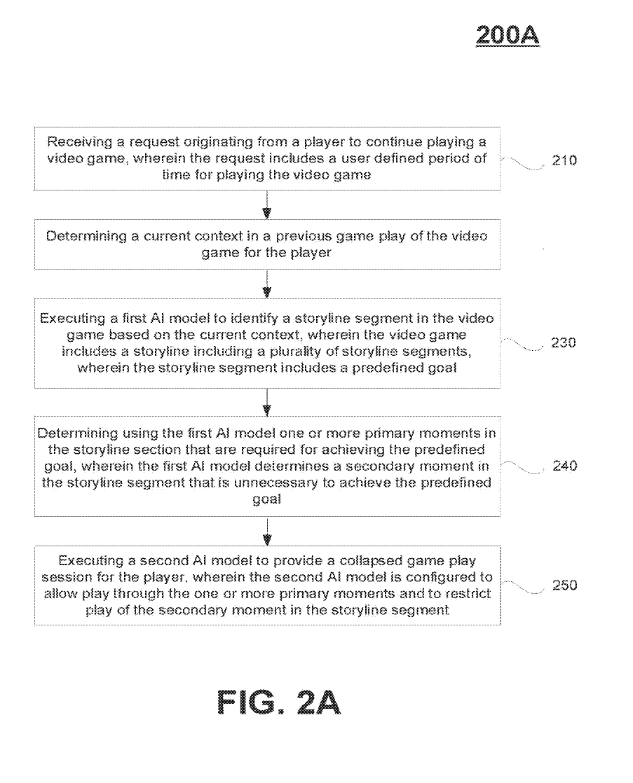

With the detailed description of the system 100 of FIG. 1, flow diagram 200A of FIG. 2A discloses a method for providing a collapsed game play session for a video game over a user defined period of time using artificial intelligence, wherein the player is continuing previous game play of the video game, in accordance with one embodiment of the present disclosure. In that manner, a player is able to advance through the video game during the collapsed game play session, and also play moments of the game that are enjoyable to the player, even though those moments may not necessarily advance the player through the video game. The operations performed in the flow diagram may be implemented by one or more of the previously described components of system 100 described in FIG. 1, including the audio track synchronization engine 120.

At 210, the method includes receiving a request originating from a player to continue playing a video game, wherein the request includes a user defined period of time for playing the video game. For example, the player has a limited amount of time to play the video game, which can be specified by the player. The request may be received while the player has already initiated an instance of the video game, which allows the user to continue playing the video game but in a shorted period of time. For instance, the player may know that a boss battle is coming up, but wants to advance quickly to the boss battle and battle the boss in the remaining time the player has devoted to playing the video game. As such, the request transitions from a regular and unrestricted play of the video game to a collapsed or condensed play of the video game that guides the player through essential moments that advance the player through the video game. The request may also be received before the video game has been instantiated. For instance, the request may originate via a user interface that identifies the video game and the game play of the player, or in the opening pages when loading up the video game for playing. In either case, the collapsed game play is a continuation of previous game plays of the video game for that player.

At 220, the method includes determining a current context in the previous game play of the video game for the player. For instance, because the player is continuing to play the video game, the context of when the player last played the video game, or the context of the video game that has been instantiated is determined. In one embodiment, artificial intelligence (AI) is used to determine the game context. One or more types of information may be analyzed by the artificial intelligence (e.g., an AI model trained to determine game context of a corresponding video game) to determine the game context. Because the player is continuing to play the video game, the information may include game state data, screen shot data from previous game plays, and other relevant information. For example, the AI model is trained to identify a plurality of contexts of a plurality of points in any game play of the video game, and is configured to classify and/or identify a context of a game play of the video game for that player.

At 230, the method includes executing a first AI model to identify a storyline segment in the video game based on the current context. For example, the first AI model may be configured to analyze a first plurality of game plays of the video game by a plurality of players to determine a storyline of the video game, and a plurality of storyline segments. In particular, a plurality of features is extracted and/or classified for use by the AI model, wherein the AI model is configured to analyze the plurality of features to determine the storyline and the storyline segments. For example, the AI model may analyze game state data from the game plays of the video game by a plurality of players for purposes of determining the storyline and/or the storyline segments. That is, the first AI model is trained to identify the overall storyline (e.g., story arc) which includes the plurality of storyline segments.

Each of the storyline segments includes a corresponding goal that is predefined. The goal may be minimally impactful (e.g., traversing to a location of a map showing the gaming environment), or highly impactful (e.g., engaging in a boss battle). For purposes of illustration only, a predefined goal may include a boss fight, completion of a task, communicating with a non-player character (NPC), or obtaining an asset, as well as others.

Further, the first AI model is configured to identify the storyline segment corresponding with the current game context that is determined. Also, the storyline segment includes or is associated with a particular predefined goal. That is, in the video game, while playing through the storyline segment, experiencing and/or achieving the predefined goal advances the game play of the video game by the player.

The first AI model may be executed to determine a plurality of moments in the plurality of storyline segments. A moment may include interactions with a gaming environment that may or may not be significant to the game play, and may or may not progress the game play. Other moments may be important to the experience of the player, and are personal or specific to the game play of the player, such as performing or finishing one or more side quests for a player that enjoys side quests. The interactions may be centered around a character that is controlled by the player. For purposes of illustration, moments may include, in part, areas or regions visited within the gaming environment, various interactions within a level, side quests started, quests played, quests completed, achievements, tasks started and/or completed, earning assets (e.g., weapons, treasure, etc.) that are necessary or unnecessary, battling a boss, beating a boss, passing a level, interactions with NPCs, etc. In one embodiment, one or more moments are tagged in the video game by the developer of the video game, wherein the tagging may be used by the first AI model for identifying corresponding moments.

At 240, the method includes determining using the first AI model one or more primary moments in the storyline segment. That is, once the storyline segment is identified, the first AI model may be executed to determine a plurality of moments for that storyline segment. Further, the first AI model may be executed to determine the primary moments that are required for achieving the predefined goal for that storyline segment. For example, a primary moment may include communicating with an NPC, obtaining a necessary asset for achieving the predefined goal (e.g., beating a boss), and/or performing the last moment in the storyline segment (e.g., battling a boss), etc.

In addition, the first AI model may be executed to determine a secondary moment in the storyline segment, wherein a secondary moment is unnecessary to achieve the predefined goal. For example, a secondary moment may include performing a side quest, or battling a creature encountered in the storyline segment, and others.

At 250, the method includes executing a second AI model to provide a collapsed game play session for the player, wherein the second AI model is configured to allow play through the one or more primary moments and to restrict play of the secondary moment in the storyline segment. In particular, a plurality of features is extracted and/or classified for use by the second AI model, wherein the second AI model is configured to analyze the plurality of features to determine the how the video game is being executed. For example, the AI model may analyze the game state data from executing the game play to allow for execution of commands related to the primary moments, and/or to restrict execution of commands related to the secondary moment. As such, the second AI model is configured to influence execution of the video game, including enabling play of the primary moments, including guiding or encouraging the user to play the primary moments in the storyline segment, and further including restricting play of the secondary moment, such that the secondary moment cannot be played in the collapsed game play session.

In another embodiment, a secondary moment may be elevated to a primary moment based on a gaming style of the player, or through user interaction with preferences and/or player characteristics in the gaming style of that player. In that manner, these modifications may be used to influence which moments can be played in the collapsed game play session, and which moments are restricted. For example, even though a side quest in the storyline segment is unnecessary, the player always plays side quests. As such, based on user preferences learned through historical game play of one or more video games, or user input that modifies the user preferences, a side quest may be changed from a secondary moment to a primary moment.

In one embodiment, the collapsed game play session is terminated, thereby allowing regular or normal play of the video game (e.g., play without restrictions). A transition scene may be provided between the collapsed game play session and the subsequent regular game play. In one implementation, the video game session is completed automatically terminated (e.g., exiting the video game), as the player has indicated that they can only play the game for the user defined period of time. After or during termination, the game play of the video game is saved, such as saving game state from the collapsed game play session.

Termination of the collapsed game play session may be triggered by one or more conditions. For example, termination may be executed once it is determined that the user defined period of time has expired. In another case, termination may be executed once it determined that predefined goal has been achieved. In still another case, termination may be executed once the user requests cancellation of the collapsed game play mode or feature (e.g., via user interface).

In one embodiment, after termination of the collapsed game play session, play of the secondary moment is allowed. That is, the restriction from playing the secondary moment, as implemented during the collapsed game play session, is lifted such that the player may go back and play that secondary moment. For instance, the player may return to play a side quest that is a secondary moment, such as after termination of the collapsed game play session.

With the detailed description of the system 100 of FIG. 1, flow diagram 200B of FIG. 2B discloses a method for providing a collapsed game play session for a video game over a user defined period of time using artificial intelligence, wherein a viewer of a recorded game play of a video game by player would like to also play the video game, in accordance with one embodiment of the present disclosure. In that manner, a player is able to simulate an experience of playing a video game that is shown in the recorded game play. The operations performed in the flow diagram may be implemented by one or more of the previously described components of system 100 described in FIG. 1, including the audio track synchronization engine 120. In addition, flow diagram 200B may implement one or more operations performed in flow diagram 200A of FIG. 2A, previously described.

At 255, the method includes receiving a request to play a video clip of a recorded game play of a video game, wherein the request includes a user defined period of time for playing the video game. For example, the recorded game play may be a highlight reel of another player, or the viewer. That is, instead of just watching another player (or the same viewer) play the video game in the recorded game play, the viewer wishes to play the video game live through the same section of the video game as played in the recoded game play.

At 260, the method includes analyzing one or more screen images, or other data, of the recorded game play to determine a current context in the recorded game play of the video game. In particular, a plurality of screen shots of the game play (e.g., the video or image frames) may be captured or accessed. For example, screen shot data may be utilized when it is more suitable for processing, or when game state data is unavailable, or when game state data is too cumbersome to process. As such, the screen shot data may be analyzed to determine context of the game play shown in the recorded game play.

At 270, the method includes executing a first AI model to identify a storyline segment in the video game based on the current context of the recorded game play, wherein the video game includes a storyline including a plurality of storyline segments, wherein the storyline segment includes a predefined goal. As previously described in flow diagram 200A, the first AI model may be configured to analyze game state of game plays of the video game by one or more players, wherein the AI model is executed to determine the storyline and storyline segments. Each of the storyline segments is associated with a corresponding predefined goal, wherein the goal may be minimally impactful (e.g., traversing to a location of a map showing the gaming environment), or highly impactful (e.g., engaging in a boss battle).

More particularly, the first AI model is configured to identify the storyline segment corresponding with the game context of the game play in the recorded game play. Also, the storyline segment includes or is associated with a particular predefined goal. Playing or experiencing the predefined goal simulates the recorded game play.

At 280, the method includes determining using the first AI model one or more primary moments in the storyline segment that are required for achieving the predefined goal, wherein the first AI model determines a secondary moment in the storyline segment that is unnecessary to achieve the predefined goal. For example, the first AI model may be executed to determine a plurality of moments in the storyline segment. As previously described, a moment may include interactions with a gaming environment that may or may not be significant to the game play, and may or may not progress the game play. The interactions may be centered around a character that is controlled by the player. For purposes of illustration, moments may include, in part, areas or regions visited within the gaming environment, various interactions within a level, side quests started, quests played, quests completed, achievements, tasks started and/or completed, earning assets (e.g., weapons, treasure, etc.) that are necessary or unnecessary, battling a boss, beating a boss, passing a level, interactions with NPCs, etc. One or more moments may also be tagged by the developer of the video game.

As such, the first AI model may be executed to determine the primary moments that are required for achieving the predefined goal for that storyline segment. For example, a primary moment may include communicating with an NPC, obtaining a necessary asset for achieving the predefined goal (e.g., beating a boss), and/or performing the last moment in the storyline segment (e.g., battling a boss), etc. In addition, the first AI model may be executed to determine a secondary moment in the storyline segment.

At 290, the method includes executing a second AI model to provide a collapsed game play session for the player, wherein the second AI model is configured to allow play through the one or more primary moments and to restrict play of the secondary moment in the storyline segment corresponding with the recorded game play. For example, a plurality of features is extracted and/or classified for use by the second AI model, wherein the second AI model is configured to analyze the plurality of features to determine the how the video game is being executed. For example, the AI model may analyze the game state data from executing the game play to allow for execution of commands related to the primary moments, and/or to restrict execution of commands related to the secondary moment. As such, the second AI model is configured to influence execution of the video game, including enabling play of the primary moments, including guiding or encouraging the user to play the primary moments in the storyline segment, and further including restricting play of the secondary moment, such that the secondary moment cannot be played in the collapsed game play session.

In one implementation, the viewer owns a copy of the video game. Game state for the recorded game play may be accessed and/or determined or recreated through artificial intelligence and used to instantiate the collapsed game play session. In another implementation, the viewer is prompted to purchase a limited license to play a restricted portion of the video game, or to purchase a full license to play the video game.

The collapsed game play session of the recorded may be terminated. For example, once the predefined goal of the storyline segment is achieved, termination of the session may be implemented. Also, the game play may be restricted to an area of the gaming environment, such that the player is not given full access to the video game, but instead is given restricted access. In another implementation, the collapsed game play session may be terminated when the user defined period has elapsed.

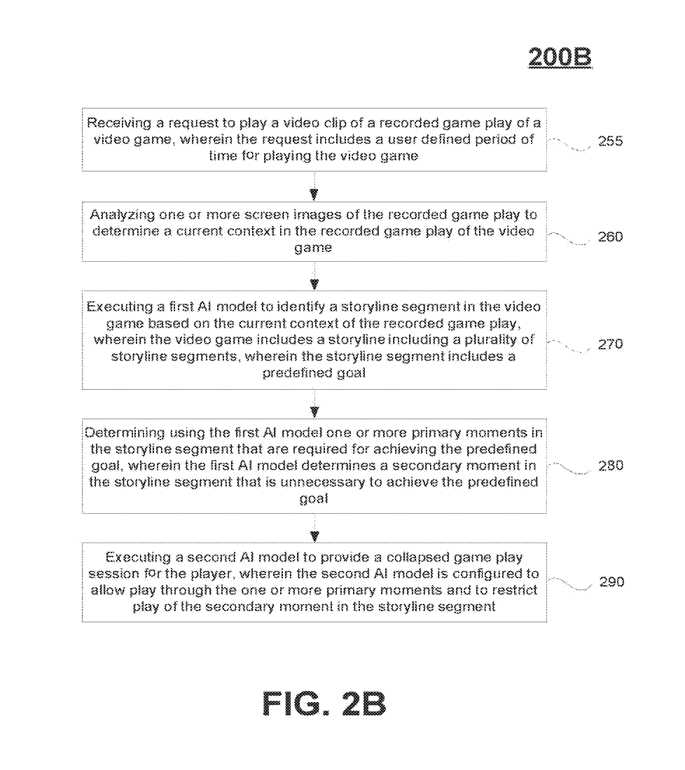

FIG. 3 is an illustration of a system configured to implement an AI model configured for implementing a collapsed game play session of a video game, in accordance with one embodiment of the present disclosure. For purposes of illustration, the system of FIG. 3 may be implemented by the cloud game network 190 or the client device 110, or a combination thereof.

In one embodiment, the system 300 may be implemented when requesting a collapsed game play of a video game by a player who has been playing the video game. For example, the request may be generated and/or received when the player is currently playing the video game (i.e., after instantiation of the video game), or before the video game has been instantiated (e.g., via a user interface). In another embodiment, the system may be implementing when a viewer of a recorded game play of a video game requests a live game play of the portion of the video game shown in the recorded game play.

In each of these implementations, FIG. 3 is an illustration of an implementation of AI model 170 that is trained, in part, to identify and/or classify a storyline segment of a video game based on a game context, for purposes of determining primary moments that are necessary for achieving a predefined goal of the storyline segment, and/or a secondary moment that is unnecessary for aching the predefined goal. Further, the AI model 170 may be used for controlling and/or implementing a collapsed gameplay session that allow play through primary moments and/or restricts play through the second moment of the storyline segment.

In particular, data 305 and 320 are captured for input into the deep/machine learning engine 195, trained to perform collapsed gaming of a video game by applying machine learning. The data may be collected through a communication network 150, or directly delivered. For example, data 320 used for determining, in part, a game context of a game play includes game state data 321 from a game play of the video game by the player requesting the collapsed game play session; game state data 322 from a plurality of game plays of the video game by a plurality of players; and a video clip 323 of recorded game play, including a plurality of screen shots and/or video frames from a corresponding game play of the video game. For example, a developer of the video game may allow for access to the game state on developer servers, or for the game state to be streamed (e.g., for use by the collapsed game play engine 120). In addition, data 305 used for identifying primary and secondary moments of an identified storyline segments includes, in part, a storyline 306 identified using artificial intelligence that analyses the game state of game plays of the video game by one or more players, and a plurality of storyline segments 307 of the storyline; one or more tagged moments 308 of the video game, for example that are tagged by the developer of the video game; and modifiers 309 to one or more player characteristics that are provided via a user interface.

Specifically, game state data defines the state of the game play of an executing video game for a player at a particular point in time. Game state data allows for the generation of the gaming environment at the corresponding point in the game play. For example, game state data may include states of devices used for rendering the game play (e.g., states of the CPU, GPU, memory, register values, etc.), identification of the executable code to execute the video game at that point, game characters, game objects, object and/or game attributes, graphic overlays, and other information. Game state may also include user saved data includes information that personalizes the video game for the corresponding player. For example, user saved data may include character information and/or attributes that are personalized to a player (e.g., location, shape, look, clothing, weaponry, assets, etc.) in order to generate a character and character state that is unique to the player for the point in the game play, game attributes for the player (e.g., game difficulty selected, player customized game settings, game level, character attributes, character location, number of lives, trophies, achievements, rewards, etc.), user profile data, and other information. Game state may include metadata that is configured to provide relational information and/or context for other information, such as the game state data and the user saved data. For example, metadata may include information describing the gaming context of a particular point in the game play of a player, such as where in the game the player is, type of game, mood of the game, rating of game (e.g., maturity level), the number of other players there are in the gaming environment, game dimension displayed, the time of the collection of information, the types of information collected, region or location of the internet connection, which players are playing a particular gaming session, descriptive information, game title, game title version, franchise, format of game title distribution, network connectivity, downloadable content accessed, links, language, system requirements, hardware, credits, achievements, awards, trophies, and other information.

Data 320 and/or data 305 may be provided to the feature extractor 310 to identify salient and relevant information used for collapsing gaming of a video game using artificial intelligence, etc. For example, the feature extractor may be configured to define features useful in identifying a current game context of the game play or a recorded game play of a video game, a storyline and storyline segments of the video game, a particular storyline segment based on the current game context that is identified, primary and secondary moments of the storyline segment that is identified, and for controlling the collapsed game play session, etc. Further, the extracted features may be classified and/or labeled by the classification/label engine 315 prior to submission to the AI model 170 as input 316. In some implementations, data 320 and 305 may be provided directly to the machine learning engine 195, such as when feature extraction and/or classification are performed internally by the AI model, or for use by the AI model 170 (e.g., storyline and/or storyline segment identification, tagged moments, etc.).

As shown, the deep/machine learning engine 195 is configured for implementation of AI model 170 based on an input set of data (e.g., extracted features that may be further classified and/or labeled. In one embodiment, the AI model 170 is a machine learning model configured to apply machine learning to implement a collapsed game play session. In another embodiment, the AI learning model is a deep learning model configured to apply deep learning to perform the same operations, wherein machine learning is a sub-class of artificial intelligence, and deep learning is a sub-class of machine learning. As such, artificial intelligence is used for implementing a collapsed game play session of a video game currently being played by a player, or via a recorded game play of the video game (e.g., highlight reel).

Purely for illustration, the deep/machine learning engine 195 may be configured as a neural network used to train and/or implement the AI model 170, in accordance with one embodiment of the disclosure. Generally, the neural network represents a network of interconnected nodes, such as an artificial neural network, and is configured for responding to input (e.g., extracted features) and generating an output related controlling and/or implementing a collapsed game play session of a video game.

In one implementation, the AI neural network includes a hierarchy of nodes. For example, there may be an input layer of nodes, an output layer of nodes, and intermediate or hidden layers of nodes. Input nodes are interconnected to hidden nodes in the hidden layers, and hidden nodes are interconnected to output nodes. Each node learns some information from data. Knowledge can be exchanged between the nodes through the interconnections. Interconnections between nodes may have numerical weights that may be used link multiple nodes together between an input and output, such as when defining rules of the AI model 170. Input to the neural network activates a set of nodes. In turn, this set of nodes activates other nodes, thereby propagating knowledge about the input. This activation process is repeated across other nodes until an output is provided.

For example, the AI model 170 is configured to apply rules defining relationships between features and outputs, wherein features may be defined within one or more nodes that are located at one or more hierarchical levels of the AI model 170. The rules link features (as defined by the nodes) between the layers of the hierarchy, such that a given input set of data leads to a particular output (e.g., a game context of a game play of a video game, a storyline segment corresponding with the game context, primary and secondary moments of the storyline segments, etc.) of the AI model 170. For example, a rule may link (e.g., using relationship parameters including weights) one or more features or nodes throughout the AI model 170 (e.g., in the hierarchical levels) between an input and an output, such that one or more features make a rule that is learned through training of the AI model 170. That is, each feature may be linked with one or more features at other layers, wherein one or more relationship parameters (e.g., weights) define interconnections between features at other layers of the AI model 170. As such, each rule or set of rules corresponds to a classified output.

The AI model 170 is executed for a given set of extracted features that are classified and provided as input 316. In particular, data relevant for providing a collapsed game play session of a video game using artificial intelligence is generated according to the rules of the AI model 170. As such, the AI model may be executed to perform one or more interim processes, each of which is configured to identify/determine/generate/classify data, which are used for implementing a collapsed game play session using the AI model 170. In particular, the AI model 170 may be configured as one or more AI models, each of which is configured to perform a specific function, and output data, previously described, that may be used by another AI model.

For example, the AI model 170 is configured at least to identify and/or classify and/or generate one or more of the following data 340 used for providing a collapsed game play session. For example, the AI model 170 may be configured to determine and/or identify game context 343 of a game play of a video game. As previously described, game state of a plurality of game plays of the video game by one or more players may be analyzed to determine a plurality of game contexts. In that manner, game state of a particular game play of the video game may be analyzed to determine a current game context for that game play.

Further, the AI model 170 may be configured to determine and/or identify a storyline segment 344 corresponding with the identified game context. The AI model may also be configured to determine the overall storyline and a plurality of storyline segments based on an analysis of game state of plurality of game plays of the video game by one or more players. Each of the storyline segments corresponds with a predefined goal that may or may not be significant to the game play of the video game. In that manner, game state of a particular game play of the video game may be analyzed to determine the storyline segment 344.

Further, the AI model 170 may be configured to determine and/or identify a plurality of moments 331 in the storyline segment, and more particularly moments of a predicted path taken by the player through the storyline segment. In particular, the AI model is configured to identity one or more primary moments of the identified storyline segment, wherein a primary moment is required for achieving the predefined goal of the storyline segment. In addition, the AI model is configured for identifying a secondary moment of the identified storyline segment, wherein the secondary moment is unnecessary for achieving the predefined goal.

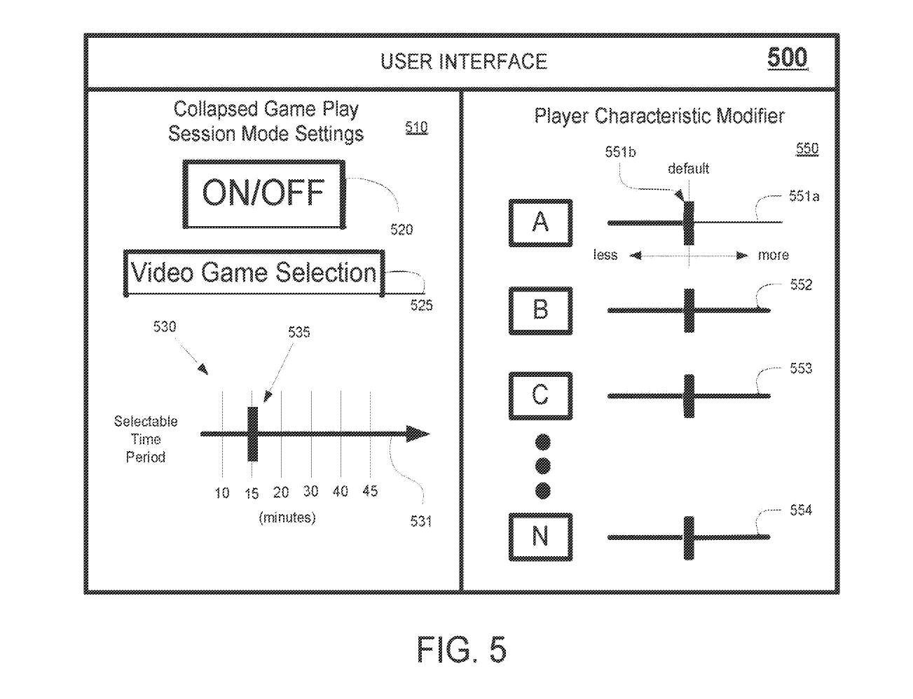

More particularly, the AI model 170 may be configured to analyze a plurality of game plays (e.g., second plurality) of a plurality of video games played by the player to determine a universal game play style 341 of the player. In addition, the player may play the video game differently in a manner that is inconsistent with the universal game play style. For instance, the universal game play style may indicate that the player does not play side quests normally. However, for some reason the player may actively play side quests in the current video game. As such, the AI model is configured to analyze another plurality of (e.g., third plurality) game plays of the video game played by the player to determine a plurality of patterns of the player when playing the video game. In another embodiment, the player may actively change user preferences or characteristics of the game play style in a user interface (see FIG. 5 for a more detailed discussion). The AI model 170 may be further configured to modify the universal game play style 341 based on the plurality of patterns, and generate a modified game play style for the player 342. This modified game play style may be used to identify changes to labeling of primary moments in the storyline segment, and/or secondary moments. For instance, a side quest that is normally a secondary moment may be preferred to be played by the player and may be relabeled as a primary moment.

In particular, the AI model may be used to identify a plurality of paths 332 through the storyline segment that can be taken, traversed, and/or played. Further, the modified game play style may be used to determine a predicted path 333 taken by the player by the AI model. For example, the AI model may subsequently determine that a first primary moment or another secondary moment in the predicted path is undesired by the player based on the universal game play style that is modified, wherein the one or more primary moments initially determined includes the first primary moment. In that manner, when implementing the collapsed game play session, the first primary moment and/or the another secondary moment may be further restricted from being played.

Furthermore, the AI model may subsequently determine that a first primary moment or another secondary moment in the predicted path is desired by the player based on the universal game play style that is modified. In that manner, when implementing the collapsed game play session, the first primary moment and/or the another secondary moment may be allowed to be played, and/or emphasized for playing.

As such, the resulting output 350 may be used for implementing and/or controlling the collapsed game play session of the video game using artificial intelligence. In particular, the output may include the primary and secondary moments in the predicted path taken by the player that are identified, as previously described. In particular, an AI model may be configured as a collapsed game play controller 360 to implement and/or control the collapsed game play session. For example, based on the output 350, the guiding engine 361 allows for primary moments to be played during the collapsed game play session. In particular, artificial intelligence may be used to identify instructions to be executed in the video game related to the one or more primary moments of the storyline segment, and to allow execution of those instructions during the collapsed game play session. Also, based on the output 350, the restriction engine 362 restricts the secondary moment from being played during the collapsed game play session. In particular, artificial intelligence may be used to identify instructions to be executed in the video game related to the secondary moment of the storyline segment, and restrict execution of those instructions during the collapsed game play session.

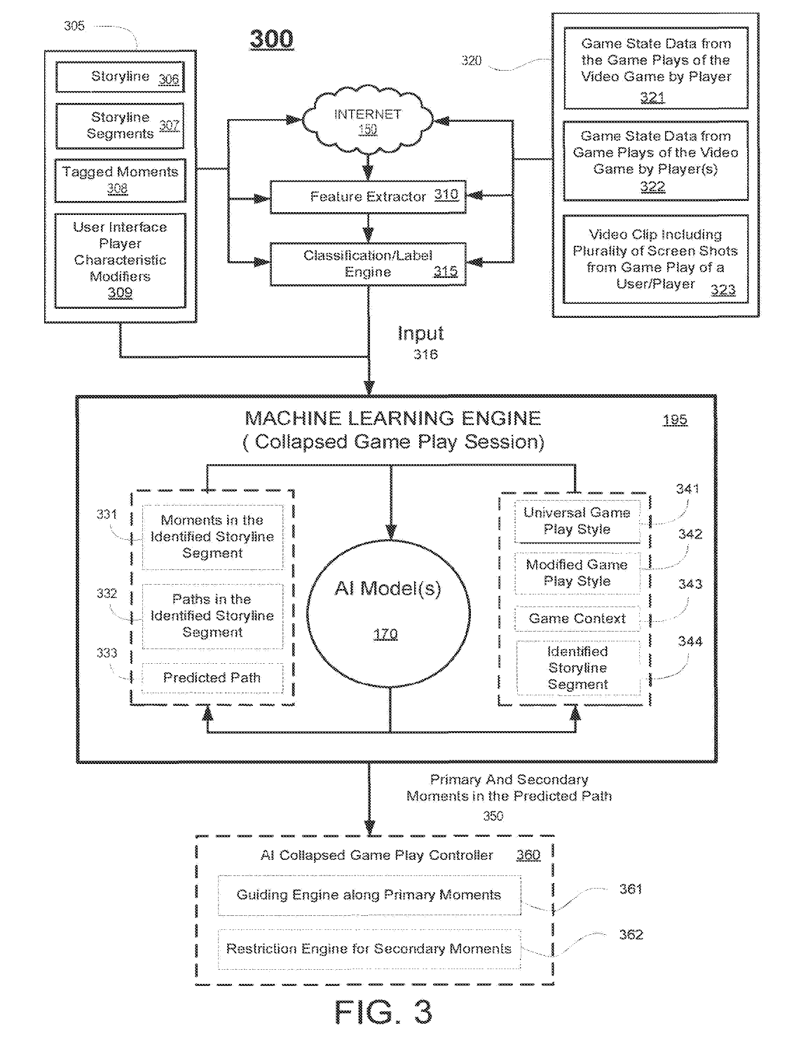

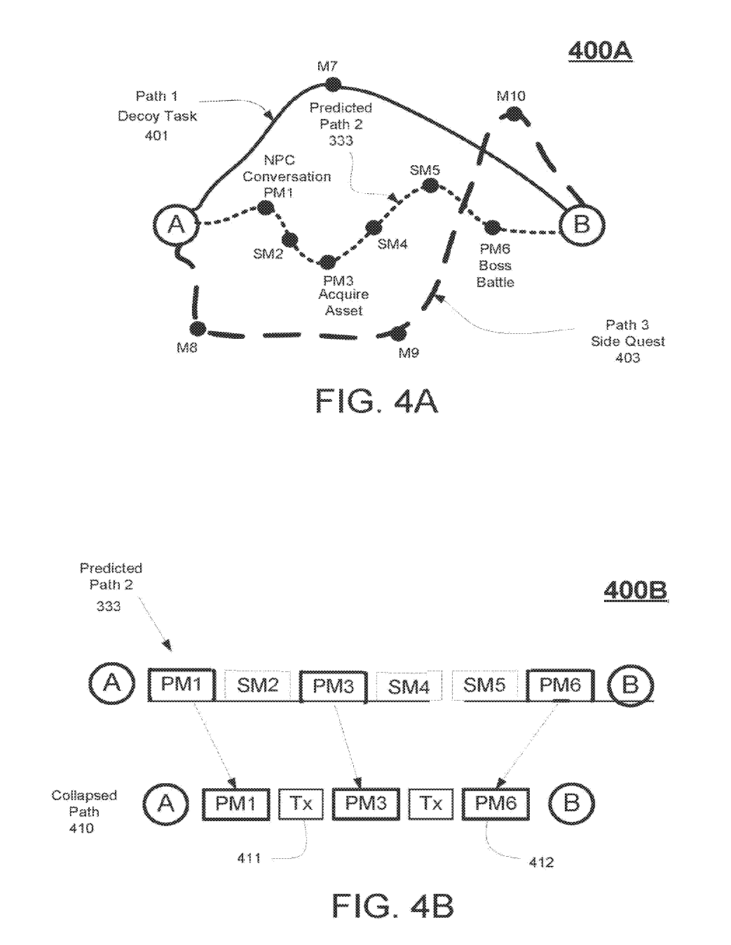

FIG. 4A is a diagram 400A illustrating one or more paths capable of being played for a storyline segment of a video game, in accordance with one embodiment of the present disclosure. In particular, a storyline segment may be associated with traversing through the video game from point A to point B. Once the storyline segment is identified, a plurality of paths may be identified using artificial intelligence, such as through analysis of a plurality of game plays of the video game by one or more players. For example, the storyline line segment may include path 1 (401) (including moment M7), which is a decoy task unnecessary for achieving the predefined goal of the storyline segment; path 2 (333) (including primary moments PM1, PM3, and PM6 and secondary moments SM2, SM4, and SM5), which may be a main or necessary path; and path 3 (403) (including moments M8 and M9 and M10), which is a side quest that may be unnecessary for achieving the predefined goal of the storyline segment.

As previously described, a universal game play style and/or a universal game play style that is modified, each of which is generated based on historical game plays by the player of one or more video games and/or the instant video game, may be used to determine a predicted path through the storyline segment using artificial intelligence. In particular, artificial intelligence is used to determine the predicted path based on either the universal game play style and/or a universal game play style that is modified.

Further, artificial intelligence is used, based on the universal game play style and/or a universal game play style that is modified, to determine that one or more primary moments along the predicted path. For example, the predicted path 333 (path 2) may include primary moment PM1 (a communication with an NPC), and primary moment PM3 (for acquiring an asset necessary to achieve the predefined goal of the storyline segment), and primary moment PM6 (boss battle). Also, artificial intelligence is used, based on the universal game play style and/or a universal game play style that is modified, to determine at least one secondary moment in the predicted path. Further, artificial intelligence is used to determine that a first primary moment and/or another secondary moment in the predicted path is undesired by the player. In that manner, the first primary moment or the another secondary moment may be restricted from being played during the collapsed game play session.

In another embodiment, artificial intelligence is used to determine that the first primary moment or the another secondary moment is desired by the player, based on the universal game play style and/or a universal game play style that is modified. In that manner, the first primary moment or the another secondary moment may be allowed to be played during the collapsed game play session. For example, a restriction on the another secondary moment originally implemented may be terminated or lifted, such that the another secondary moment is now playable.

FIG. 4B is a diagram 400B illustrating playable moments identified using artificial intelligence for a predicted path taken by a player playing a storyline segment in a collapsed game play session of a video game, in accordance with one embodiment of the present disclosure. In particular, the predicted path 333 (i.e., path 2) includes primary moments (e.g., PM1, PM3, and PM6), and secondary moments (e.g., SM 2, SM4, and SM5), as previously described. In the collapsed game play, based on the universal game play style and/or a universal game play style that is modified, primary moments are allowed to be played, while secondary moments are restricted from being played. In particular, the collapsed path 410 through the storyline segment includes primary moment PM1 (a communication with an NPC), and primary moment PM3 (for acquiring an asset necessary to achieve the predefined goal of the storyline segment), and primary moment PM6 (boss battle). One or more transitoin scenes may be inserted between moments that are played to remedy the loss of any intervening moments. That is, a transition scene may be inserted to blend between two moments being played in the storyline segment. For example, a secondary moment may be missing, wherein two primary moments surround the second moment, and a transition scene is inserted in place of the missing secondary moment. As shown, a transition scene 411 is inserted between primary moments PM1 and PM3, and a transition scene 412 is inserted between primary moments PM3 and PM6.

FIG. 5 illustrates a user interface (UI) 500 configured for enabling user modification of player characteristics corresponding to a game play style when implementing a collapsed game play session of a video game, in accordance with one embodiment of the present disclosure. The UI 500 includes a collapsed game play session mode settings section 510, and a player characteristic modifier section 550.

As shown, the collapsed game play session mode settings section 510 includes an ON/OFF mode selector 520. In that manner, the user may select to play a collapsed game play session of a current game play, or an instantiated game play, or during a recorded game play. For example, when playing a video game, or viewing a recorded game play, the UI 500 may be initiated to begin a collapsed game play session. Further, when there is no current game play session of a video game, and no viewing of a recorded game play, the UI 500 may be initiated to begin a collapsed game play session of a video game that is selected via interface 525. For example, interface 525 may allow the player to insert (e.g., via text) or select via a drop down menu a video game owned by the player. In addition, the ON/OFF mode selector 520 may be used to cancel or terminate an existing collapsed game play session.

Furthermore, an interactive time selector 530 may be used to select a user defined period of time to play the collapsed game play session. For example, a timeline 531 may show increments of time, including 5 minute intervals between 10 and 45 minutes. A slidable selector 535 is used to select the amount of time for the user defined period of time. As shown, the player would like to play a collapsed game play session of a video game for 15 minutes.

The player characteristic modifier section 550 lists a plurality of player characteristics (A through N) that are defined and/or used to generate a game play style (e.g., starting with the universal game play style) for the player. For example, player characteristics may include whether the player likes to play side quests, or how fast the player goes through a video game, whether the player likes to explore all parts of the gaming world, whether the player hates to explore the gaming world, whether the player likes or dislikes engaging with creatures in battle, etc. Each of the listed player characteristics includes a corresponding sliding selector that can be manipulated by the player to increase or decrease that characteristic when generating the game play style. Manipulation of one or more player characteristics will modify the universal game play style. For example, player characteristic A includes a bar 551a with a slidable selector 551b, wherein movement to the right of a default center increases the influence of the player characteristic A when modifying the universal game play style, and movement to the left of the default center decreases the influence of the player characteristic A when modifying the universal game play style. Other player characteristics are similarly modifiable using corresponding bars and slidable selectors. For example, player characteristic B includes bar 552 with a slidable selector that is initially positioned in a neutral (non-influential) default position; player characteristic C includes bar 553 with a slidable selector that is initially positioned in a neutral (non-influential) default position; and player characteristic N includes bar 554 with a slidable selector that is initially positioned in a neutral (non-influential) default position. In that manner, once a modification to a player characteristic is received, artificial intelligence may be executed to modify the universal game play style based on the modification.

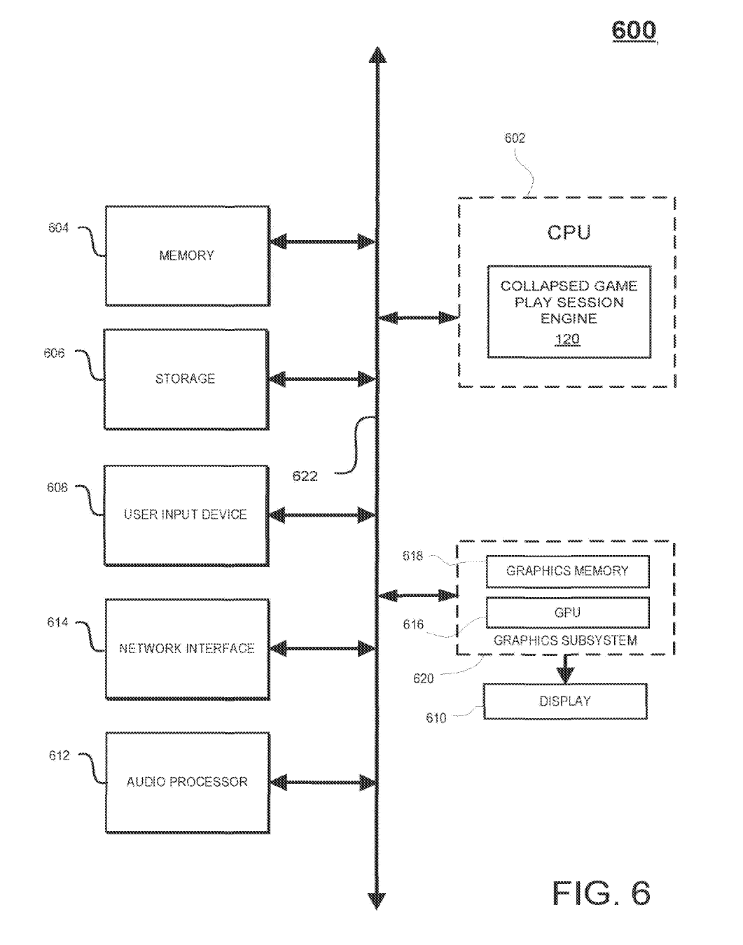

FIG. 6 illustrates components of an example device 600 that can be used to perform aspects of the various embodiments of the present disclosure. This block diagram illustrates a device 600 that can incorporate or can be a personal computer, video game console, handheld video game console, personal digital assistant, a server or other digital device, and includes a central processing unit (CPU) 602 for running software applications and optionally an operating system. CPU 602 may be comprised of one or more homogeneous or heterogeneous processing cores. Further embodiments can be implemented using one or more CPUs with microprocessor architectures specifically adapted for highly parallel and computationally intensive applications.

In particular, CPU 602 may be configured to implement a collapsed game play session engine 120 that is configured to provide a collapsed gaming experience for a video game over a defined period of time, that is customized to include essential moments with consideration of a universal gaming style of the player and historical game play of the video game by the player. In particular, artificial intelligence can be used to identify a storyline segment for a corresponding point in the game (e.g., current game context in an on-going game play or in a recorded game play session), and identify one or moments associated with that storyline segment that are necessary for completing that storyline segment. Artificial intelligence is used to control a collapsed game play session for a user defined period of time that guides the player through those essential moments and restricts play of moments that are not necessary for completing the storyline segment. In that manner, the corresponding player is able to efficiently play the video game in a shortened amount of time by still advancing through the video game.

Memory 604 stores applications and data for use by the CPU 602. Storage 606 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 608 communicate user inputs from one or more users to device 600, examples of which may include keyboards, mice, joysticks, touch pads, touch screens, still or video recorders/cameras, tracking devices for recognizing gestures, and/or microphones. Network interface 614 allows device 600 to communicate with other computer systems via an electronic communications network, and may include wired or wireless communication over local area networks and wide area networks such as the internet. An audio processor 612 is adapted to generate analog or digital audio output from instructions and/or data provided by the CPU 602, memory 604, and/or storage 606. The components of device 600 are connected via one or more data buses 622.

A graphics subsystem 620 is further connected with data bus 622 and the components of the device 600. The graphics subsystem 620 includes a graphics processing unit (GPU) 616 and graphics memory 618. Graphics memory 618 includes a display memory (e.g., a frame buffer) used for storing pixel data for each pixel of an output image. Pixel data can be provided to graphics memory 618 directly from the CPU 602. Alternatively, CPU 602 provides the GPU 616 with data and/or instructions defining the desired output images, from which the GPU 616 generates the pixel data of one or more output images. The data and/or instructions defining the desired output images can be stored in memory 604 and/or graphics memory 618. In an embodiment, the GPU 616 includes 3D rendering capabilities for generating pixel data for output images from instructions and data defining the geometry, lighting, shading, texturing, motion, and/or camera parameters for a scene. The GPU 616 can further include one or more programmable execution units capable of executing shader programs. In one embodiment, GPU 616 may be implemented within an AI engine (e.g., machine learning engine 195) to provide additional processing power, such as for the AI, machine learning functionality, or deep learning functionality, etc.

The graphics subsystem 620 periodically outputs pixel data for an image from graphics memory 618 to be displayed on display device 610. Display device 610 can be any device capable of displaying visual information in response to a signal from the device 600.

In other embodiments, the graphics subsystem 620 includes multiple GPU devices, which are combined to perform graphics processing for a single application that is executing on a CPU. For example, the multiple GPUs can perform alternate forms of frame rendering, including different GPUs rendering different frames and at different times, different GPUs performing different shader operations, having a master GPU perform main rendering and compositing of outputs from slave GPUs performing selected shader functions (e.g., smoke, river, etc.), different GPUs rendering different objects or parts of scene, etc. In the above embodiments and implementations, these operations could be performed in the same frame period (simultaneously in parallel), or in different frame periods (sequentially in parallel).

Accordingly, in various embodiments the present disclosure describes systems and methods configured for providing a collapsed gaming experience for a video game over a defined period of time, using artificial intelligence. The collapsed game play session may be customized to include essential moments with consideration of a universal gaming style of the player and historical game play of the video game by the player. In that manner, the player is able to efficiently play the video game by still advancing through the video game over a shortened amount of time, and also playing moments of the game that are enjoyable to the player.

It should be noted, that access services, such as providing access to games of the current embodiments, delivered over a wide geographical area often use cloud computing. Cloud computing is a style of computing in which dynamically scalable and often virtualized resources are provided as a service over the Internet. For example, cloud computing services often provide common applications (e.g., video games) online that are accessed from a web browser, while the software and data are stored on the servers in the cloud.

A game server may be used to perform operations for video game players playing video games over the internet, in some embodiments. In a multiplayer gaming session, a dedicated server application collects data from players and distributes it to other players. The video game may be executed by a distributed game engine including a plurality of processing entities (PEs) acting as nodes, such that each PE executes a functional segment of a given game engine that the video game runs on. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. The PEs may be virtualized by a hypervisor of a particular server, or the PEs may reside on different server units of a data center. Respective processing entities for performing the operations may be a server unit, a virtual machine, or a container, GPU, CPU, depending on the needs of each game engine segment. By distributing the game engine, the game engine is provided with elastic computing properties that are not bound by the capabilities of a physical server unit. Instead, the game engine, when needed, is provisioned with more or fewer compute nodes to meet the demands of the video game.

Users access the remote services with client devices (e.g., PC, mobile phone, etc.), which include at least a CPU, a display and I/O, and are capable of communicating with the game server. It should be appreciated that a given video game may be developed for a specific platform and an associated controller device. However, when such a game is made available via a game cloud system, the user may be accessing the video game with a different controller device, such as when a user accesses a game designed for a gaming console from a personal computer utilizing a keyboard and mouse. In such a scenario, an input parameter configuration defines a mapping from inputs which can be generated by the user's available controller device to inputs which are acceptable for the execution of the video game.

In another example, a user may access the cloud gaming system via a tablet computing device, a touchscreen smartphone, or other touchscreen driven device, where the client device and the controller device are integrated together, with inputs being provided by way of detected touchscreen inputs/gestures. For such a device, the input parameter configuration may define particular touchscreen inputs corresponding to game inputs for the video game (e.g., buttons, directional pad, gestures or swipes, touch motions, etc.).

In some embodiments, the client device serves as a connection point for a controller device. That is, the controller device communicates via a wireless or wired connection with the client device to transmit inputs from the controller device to the client device. The client device may in turn process these inputs and then transmit input data to the cloud game server via a network. For example, these inputs might include captured video or audio from the game environment that may be processed by the client device before sending to the cloud game server. Additionally, inputs from motion detection hardware of the controller might be processed by the client device in conjunction with captured video to detect the position and motion of the controller before sending to the cloud gaming server.

In other embodiments, the controller can itself be a networked device, with the ability to communicate inputs directly via the network to the cloud game server, without being required to communicate such inputs through the client device first, such that input latency can be reduced. For example, inputs whose detection does not depend on any additional hardware or processing apart from the controller itself can be sent directly from the controller to the cloud game server. Such inputs may include button inputs, joystick inputs, embedded motion detection inputs (e.g., accelerometer, magnetometer, gyroscope), etc.

Access to the cloud gaming network by the client device may be achieved through a network implementing one or more communication technologies. In some embodiments, the network may include 5th Generation (5G) wireless network technology including cellular networks serving small geographical cells. Analog signals representing sounds and images are digitized in the client device and transmitted as a stream of bits. 5G wireless devices in a cell communicate by radio waves with a local antenna array and low power automated transceiver. The local antennas are connected with a telephone network and the Internet by high bandwidth optical fiber or wireless backhaul connection. A mobile device crossing between cells is automatically transferred to the new cell. 5G networks are just one communication network, and embodiments of the disclosure may utilize earlier generation communication networks, as well as later generation wired or wireless technologies that come after 5G.

In one embodiment, the various technical examples can be implemented using a virtual environment via a head-mounted display (HMD), which may also be referred to as a virtual reality (VR) headset. As used herein, the term generally refers to user interaction with a virtual space/environment that involves viewing the virtual space through an HMD in a manner that is responsive in real-time to the movements of the HMD (as controlled by the user) to provide the sensation to the user of being in the virtual space or metaverse. An HMD can be worn in a manner similar to glasses, goggles, or a helmet, and is configured to display a video game or other metaverse content to the user. The HMD can provide a very immersive experience in a virtual environment with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user’s interaction with the VR scenes. For example, while interacting with the scenes in the game, the user may make various gestures (e.g., commands, communications, pointing and walking toward a particular content item in the scene, etc.). In one embodiment, the gestures can be tracked and processed by the system to generate a prediction of interaction with the particular content item in the game scene. In some embodiments, machine learning may be used to facilitate or assist in the prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network, such as internet, cellular, etc. In one embodiment, the cloud computing and gaming system maintains and executes the video game being played by the user. In some embodiments, the cloud computing and gaming system is configured to receive inputs from the HMD and/or interfacing objectsover the network. The cloud computing and gaming system is configured to process the inputs to affect the game state of the executing video game. The output from the executing video game, such as video data, audio data, and haptic feedback data, is transmitted to the HMD and the interface objects.

Additionally, though implementations in the present disclosure may be described with reference to an HMD, it will be appreciated that in other implementations, non-HMDs may be substituted, such as, portable device screens (e.g., tablet, smartphone, laptop, etc.) or any other type of display that can be configured to render video and/or provide for display of an interactive scene or virtual environment. It should be understood that the various embodiments defined herein may be combined or assembled into specific implementations using the various features disclosed herein. Thus, the examples provided are just some possible examples, without limitation to the various implementations that are possible by combining the various elements to define many more implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

With the above embodiments in mind, it should be understood that embodiments of the present disclosure can employ various computer-implemented operations involving data stored in computer systems. These operations are those requiring physical manipulation of physical quantities. Any of the operations described herein in embodiments of the present disclosure are useful machine operations. Embodiments of the disclosure also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server, or by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator that emulates a processing system.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

What is claimed is:

1. A method, comprising:
receiving a request originating from a player to continue playing a video game, wherein the request includes a user defined period of time for playing the video game;
determining a current context in a previous game play of the video game for the player;
executing a first AI model to identify a storyline segment in the video game based on the current context, wherein the video game includes a storyline including a plurality of storyline segments, wherein the storyline segment includes a predefined goal;
determining, using the first AI model, one or more primary moments in the storyline segment that are required for achieving the predefined goal, wherein the first AI model determines a secondary moment in the storyline segment that is unnecessary to achieve the predefined goal; and
executing a second AI model to provide a collapsed game play session for the player, wherein the second AI model is configured to allow play through the one or more primary moments and to restrict play of the secondary moment in the storyline segment.

2. The method of claim 1, further comprising:
terminating the collapsed game play session, wherein the player is able to play the video game without restrictions; and
allowing play of the secondary moment after the collapsed game play session.

3. The method of claim 2, wherein terminating the collapsed game play session includes:
determining that the user defined period of time has expired; or
determining that the predefined goal has been achieved.

4. The method of claim 1, further comprising:
analyzing a first plurality of game plays of the video game by a plurality of players;
determining the storyline and the plurality of storyline segments of the video game; and
determining a plurality of moments in the plurality of storyline segments.

5. The method of claim 4, wherein at least one of the plurality of moments is tagged in the video game by a developer of the video game.

6. The method of claim 4, further comprising:
analyzing a second plurality of game plays of a plurality of video games played by a player of the plurality of players to determine a universal game play style of the player;
analyzing a third plurality of game plays of the video game played by the player to determine a plurality of patterns of the player when playing the video game;
modifying the universal game play style based on the plurality of patterns;
determining a predicted path taken by the player based on the universal game play style that is modified;
determining a plurality of paths that can be traversed within the storyline segment;
determining a predicted path taken by the player based on the universal game play style that is modified;
determining that a first primary moment or another secondary moment in the predicted path is undesired by the player based on the universal game play style that is modified, wherein the one or more primary moments includes the first primary moment; and
restricting play of the first primary moment or the another secondary moment during the collapsed game play session.

7. The method of claim 6, further comprising:
providing a user interface including an interactive modifier configured for modifying a player characteristic in the universal game play style;
receiving a modification to the player characteristic based on an interaction with the interactive modifier; and
modifying the universal game play style based on the modification to the player characteristic.

8. A computer system comprising:
a processor;
memory coupled to the processor and having stored therein instructions that, if executed by the computer system, cause the computer system to execute a method, comprising:
receiving a request originating from a player to continue playing a video game, wherein the request includes a user defined period of time for playing the video game;
determining a current context in a previous game play of the video game for the player;
executing a first AI model to identify a storyline segment in the video game based on the current context, wherein the video game includes a storyline including a plurality of storyline segments, wherein the storyline segment includes a predefined goal;
determining, using the first AI model, one or more primary moments in the storyline segment that are required for achieving the predefined goal, wherein the first AI model determines a secondary moment in the storyline segment that is unnecessary to achieve the predefined goal; and
executing a second AI model to provide a collapsed game play session for the player, wherein the second AI model is configured to allow play through the one or more primary moments and to restrict play of the secondary moment in the storyline segment.

9. The computer system of claim 8, the method further comprising:
terminating the collapsed game play session, wherein the player is able to play the video game without restrictions; and
allowing play of the secondary moment after the collapsed game play session.

10. The computer system of claim 9, wherein in the method the terminating the collapsed game play session includes:
determining that the user defined period of time has expired; or
determining that the predefined goal has been achieved.

11. The computer system of claim 8, the method further comprising:
analyzing a first plurality of game plays of the video game by a plurality of players;
determining the storyline and the plurality of storyline segments of the video game; and
determining a plurality of moments in the plurality of storyline segments.

12. The computer system of claim 11, wherein in the method at least one of the plurality of moments is tagged in the video game by a developer of the video game.

13. The computer system of claim 11, the method further comprising:
analyzing a second plurality of game plays of a plurality of video games played by a player of the plurality of players to determine a universal game play style of the player;
analyzing a third plurality of game plays of the video game played by the player to determine a plurality of patterns of the player when playing the video game;
modifying the universal game play style based on the plurality of patterns;
determining a predicted path taken by the player based on the universal game play style that is modified;
determining a plurality of paths that can be traversed within the storyline segment;
determining a predicted path taken by the player based on the universal game play style that is modified;
determining that a first primary moment or another secondary moment in the predicted path is undesired by the player based on the universal game play style that is modified, wherein the one or more primary moments includes the first primary moment; and
restricting play of the first primary moment or the another secondary moment during the collapsed game play session.

14. The computer system of claim 13, the method further comprising:
providing a user interface including an interactive modifier configured for modifying a player characteristic in the universal game play style;
receiving a modification to the player characteristic based on an interaction with the interactive modifier; and
modifying the universal game play style based on the modification to the player characteristic.

15. A non-transitory computer-readable medium storing a computer program for performing a method, the non-transitory computer-readable medium comprising:
program instructions for receiving a request originating from a player to continue playing a video game, wherein the request includes a user defined period of time for playing the video game;
program instructions for determining a current context in a previous game play of the video game for the player;
program instructions for executing a first AI model to identify a storyline segment in the video game based on the current context, wherein the video game includes a storyline including a plurality of storyline segments, wherein the storyline segment includes a predefined goal;
program instructions for determining, using the first AI model, one or more primary moments in the storyline segment that are required for achieving the predefined goal, wherein the first AI model determines a secondary moment in the storyline segment that is unnecessary to achieve the predefined goal; and
program instructions for executing a second AI model to provide a collapsed game play session for the player, wherein the second AI model is configured to allow play through the one or more primary moments and to restrict play of the secondary moment in the storyline segment.

16. The non-transitory computer-readable medium of claim 15, further comprising:
program instructions for terminating the collapsed game play session, wherein the player is able to play the video game without restrictions; and
program instructions for allowing play of the secondary moment after the collapsed game play session.

17. The non-transitory computer-readable medium of claim 16, wherein the terminating the collapsed game play session includes:
program instructions for determining that the user defined period of time has expired; or
program instructions for determining that the predefined goal has been achieved.

18. The non-transitory computer-readable medium of claim 15, further comprising:
analyzing a first plurality of game plays of the video game by a plurality of players;
determining the storyline and the plurality of storyline segments of the video game; and
determining a plurality of moments in the plurality of storyline segments.

19. The non-transitory computer-readable medium of claim 18, further comprising:
program instructions for analyzing a second plurality of game plays of a plurality of video games played by a player of the plurality of players to determine a universal game play style of the player;
program instructions for analyzing a third plurality of game plays of the video game played by the player to determine a plurality of patterns of the player when playing the video game;
program instructions for modifying the universal game play style based on the plurality of patterns;
program instructions for determining a predicted path taken by the player based on the universal game play style that is modified;
program instructions for determining a plurality of paths that can be traversed within the storyline segment;
program instructions for determining a predicted path taken by the player based on the universal game play style that is modified;
program instructions for determining that a first primary moment or another secondary moment in the predicted path is undesired by the player based on the universal game play style that is modified, wherein the one or more primary moments includes the first primary moment; and
program instructions for restricting play of the first primary moment or the another secondary moment during the collapsed game play session.

20. The non-transitory computer-readable medium of claim 19, further comprising:
program instructions for providing a user interface including an interactive modifier configured for modifying a player characteristic in the universal game play style;
program instructions for receiving a modification to the player characteristic based on an interaction with the interactive modifier; and
program instructions for modifying the universal game play style based on the modification to the player characteristic.
